(19) United States
(12) Patent Application Publication
(10) Pub. No.: US 2026/0268281 A1
(43) Pub. Date: Sep. 10, 2026

(54) ISSUE ORCHESTRATION SYSTEM FOR GENERATING CROSS-PROJECT PROCESSES IN AN ISSUE TRACKING PLATFORM

(71) Applicant: Atlassian Pty Ltd., Sydney (AU)

(72) Inventors: David Wilson, Sydney (AU); Kris Washusen, Melbourne (AU); Jehan Gonsalkorale, Sydney (AU); Jonathan Harrison, Sydney (AU); Jacob Bass, Sydney (AU); Michael McClenaghan, Dunedin (NZ); Eryn Crowl, Melbourne (AU); Jason Thai, Sydney (AU)

(21) Appl. No.: 19/088,951

(22) Filed: Mar. 24, 2025

Related U.S. Application Data
(60) Provisional application No. 63/768,789, filed on Mar. 7, 2025.

(51) Int. Cl. G06Q 10/10; G06F 3/04842; G06Q 10/0631

(52) U.S. Cl. CPC G06Q 10/103; G06F 3/04842; G06Q 10/063114

(57) ABSTRACT

Embodiments described herein relate to methods and systems for defining and executing a cross-project orchestration process. The methods and systems can cause display of an orchestration system user interface having a rule-library panel defining one or more issue definition blocks and a rule-generation panel configured to receive issue definitions blocks and define a dependent relationship between one or more of the issue definition blocks. The orchestration system user interface can be used to generate an orchestration process flow. The orchestration process flow can include multiple issue definition blocks displayed in the rule-generation panel. Each issue definition block can define one or more issue parameters used to generate a respective issue at an issue tracking system. Placement of an issue definition block with respect to other issue definition blocks can define a dependent relationship of the respective issues at the issue tracking system.

### CROSS REFERENCE TO RELATED APPLICATIONS

This application is a nonprovisional of and claims the benefit under 35 U.S.C. § 119(e) of U.S. Provisional Patent Application No. 63/768,789 filed Mar. 7, 2025, the contents of which are incorporated herein by reference as if fully disclosed herein.

### TECHNICAL FIELD

Embodiments described herein relate to issue tracking platforms that are used to manage issues, and more particularly to systems and methods for creating, managing, storing, sharing, and modifying issue data.

### BACKGROUND

An organization can employ software tools to assist with technical problems and interruptions in technical service. Typically, an issue tracking system or similar software platform may be used to create, track, and manage issues that relate to technical problems logged by system users. In some traditional systems, the creation and management of issues is largely a manual process and results in custom defined projects and respective issues. Generating cross-project issues and managing dependencies in a uniform manner may be difficult using some traditional systems. Further, it can be difficult to visually track the status and progression of issues that may be related to an overall set of operations or initiative.

### SUMMARY

Embodiments described herein are directed to a method for defining a cross-project orchestration process. The method can include causing display of an orchestration system user interface having a rule-library panel defining one or more issue definition blocks and a rule-generation panel configured to receive issue definition blocks and define a dependent relationship between one or more of the issue definition blocks. In response to receiving one or more inputs to the orchestration system user interface, the method can include generating an orchestration process flow. The orchestration process flow can include a trigger object displayed in the rule-generation panel. The trigger object can be configured to receive data from an external application platform and define one or more trigger conditions based on the received data. The orchestrion process flow can include a parent issue definition block displayed in the rule-generation panel. The parent issue definition block can define one or more issue parameters used to generate a parent issue at an issue tracking system and the generation of the first parent issue is initiated by the one or more trigger conditions. The orchestration process flow can include a first issue definition block displayed in the rule-generation panel. The first issue definition block can have a first dependent relationship to the parent issue definition block and include first issue data used to generate a first issue at the issue tracking system. The first dependent relationship can be used to define a first dependent relationship between the parent issue and the first issue at the issue tracking system. The orchestration process flow can include a second issue definition block displayed in the rule-generation panel. The second issue definition block can have a second dependent relationship to the parent issue definition block and include second issue data used to generate a second issue at the issue tracking system. The second dependent relationship can be used to define a second dependent relationship between the parent issue and the second issue at the issue tracking system. The orchestration process flow can include a condition element block displayed in the rule-generation panel and connecting the second issue definition block to the parent issue definition block. The condition element block can define one or more conditions for initiating the creation of the second issue at the issue tracking system. The method can include, subsequent to completion of the orchestration process flow and in response to determining, by an issue creation system, an occurrence of the one or more trigger conditions, causing generation of one or more issues at the issue tracking system in accordance with the orchestration process flow.

Embodiments are also directed to a method for defining a cross-project orchestration process. The method can include causing display of an orchestration system user interface having a rule-library panel defining one or more issue definition blocks and a rule-generation panel configured to receive issue definition blocks and define a dependent relationship between one or more of the issue definition blocks. In response to receiving one or more inputs to the orchestration system user interface, the method can include generating an orchestration process flow comprising a trigger object displayed in the rule-generation panel. The trigger object can be configured to receive data from an external application platform and define one or more trigger conditions based on the received data. The orchestration process flow can include multiple issue definition blocks displayed in the rule-generation panel. Each issue definition block can define one or more issue parameters used to generate a respective issue at an issue tracking system. The multiple issue definition blocks can include a first issue definition block defining one or more first issue parameters used to generate a first issue at an issue tracking system, and a second issue definition block defining one or more second issue parameters used to generate a second issue at the issue tracking system. Placement of the second issue definition block with respect to the first issue definition block can define a dependent relationship of the first issue with respect to the second issue at the issue tracking system. The method can include, subsequent to completion of the orchestration process flow and in response to determining an occurrence of the one or more trigger conditions, causing generation of one or more issues at the issue tracking system in accordance with the orchestration process flow.

Embodiments are further directed to an issue orchestration system operating on one or more servers and comprising a backend application operably coupled to a frontend application operating on a client device. The issue orchestration system backend application can be configured to cause display, at the frontend application, of an orchestration system user interface having a rule-library panel comprising one more issue definitions blocks and a rule-generation panel configured to receive issue definition blocks and define a dependent relationship between one or more of the issue definition blocks. in response to receiving one or more inputs to the orchestration system user interface, the backend application can be configured to generate an orchestration process flow. The orchestration process flow can include a trigger object configured to receive data from an external application platform and define one or more trigger conditions based on the received data. The orchestration process flow can include multiple issue definition blocks each defining one or more issue parameters used to generate a respective issue at an issue tracking system. The multiple issue definition blocks can include a first issue definition block defining one or more first issue parameters used to generate a first issue at an issue tracking system, and a second issue definition block defining one or more second issue parameters used to generate a second issue at the issue tracking system. The orchestration process flow can define a dependent relationship of the first issue with respect to the second issue at the issue tracking system. The backend application can be configured to, subsequent to completion of the orchestration process flow and in response to determining an occurrence of the one or more trigger conditions, cause generation of one or more issues at the issue tracking system in accordance with the orchestration process flow.

### BRIEF DESCRIPTION OF THE DRAWINGS

Reference will now be made to representative embodiments illustrated in the accompanying figures. It should be understood that the following descriptions are not intended to limit this disclosure to one included embodiment. To the contrary, the disclosure provided herein is intended to cover alternatives, modifications, and equivalents as may be included within the spirit and scope of the described embodiments, and as defined by the appended claims.

FIG. 1 depicts a diagram of a system for implementing a cross-product orchestration process, as described herein.

FIG. 2 depicts a diagram of a cross-product orchestration system and an issue tracking system.

FIG. 3 depicts an example process for defining and executing a cross-product orchestration.

FIG. 4 depicts an example orchestration system user interface for generating a cross-product orchestration process.

FIG. 5 depicts an example logic interface used to define a logic parameter for an issue definition block.

FIG. 6 depicts an example editing interface used to define one or more issue parameters for an issue definition block.

FIG. 7 depicts an example orchestration system user interface for generating a cross-product orchestration process.

FIG. 8 depicts an example orchestration system user interface including one or more status indicators for an orchestration process flow.

FIG. 9 depicts an example issue view for an issue managed by an issue tracking system.

FIG. 10 depicts an example frontend interface that supports automation rule creation and automated content assessment for issue tracking systems.

FIG. 11 depicts an example frontend interface that supports automation rule creation and automated content assessment for issue tracking systems.

FIG. 12 shows a sample electrical block diagram of an electronic device.

The use of the same or similar reference numerals in different figures indicates similar, related, or identical items.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Embodiment described herein are directed to systems and processes for creating orchestration process flows which include data structures that are used to generate issues at an issue tracking system, define dependencies between the created issues and share data between issues. An orchestration process flow can be generated using an orchestration system user interface that includes a rule-library panel and a rule-generation panel. The rule-library panel can include one or more issue definition blocks which include data structures used to define issue parameters that are used to create an issue at an issue tracking system and conditions for initiating the creation of a respective issue at the issue tracking system.

The orchestration system user interface can be configured to allow a user to add issue definition blocks to the rule-generation panel (e.g., by adding them directly to the rule-generation panel, by dragging and dropping issue definition blocks from the rule-library panel, and so on as described herein). The arrangement of the issue definition blocks in the rule-generation panel can be used to define dependencies between the respective issues as they are created at the issue tracking system. For example, issue definition blocks may be arranged in the rule-generation panel using a hierarchal tree structure, where dependent issues are displayed in a nodal relationship to a parent issue. The arrangement of the issue definition blocks in the orchestration system user interface, the defined issue parameters for each issue definition block and the defined issue creation conditions (an “orchestration process flow”) can define the interrelation/dependencies of project data, issues corresponding to the project(s) and creation conditions prior to the issues being created at the issue tracking system. Accordingly, as the issues are created at the issue tracking system the orchestration process flow can cause the issue tracking system to populate the issues with data from other issues and/or projects and define dependencies (or other relationships) to other issues managed by the issue tracking system.

An issue tracking system can be configured to generate and manage issues to assist with a problem or other tasks. An issue can be associated with issue data (which also may be referred to as issue attributes), which may include a variety of information including a request type, an issue title, a summary of the issue input by a requesting user, and/or other information that is created at the time of the issue. In some cases, an issue definition block can be configured to generate issues having a specific request type or issue type (e.g., a specific service request type for a service request, a specific issue type for a new issue, and so), which may be stored as attributes of a respective issue. The issue tracking system (e.g., using issue attributes) may also associate other types of data with the issue, which may include workflow data. The workflow data may define a series of states that the issue or task must traverse before being completed. In some implementations, the issue is automatically processed in accordance with the states defined in the workflow, as tasks are completed, or state criteria are satisfied. The system may also track user interaction events (e.g., messages), issue state transitions, automations associated with the issue and other events that occur over the lifecycle of the issue, which may be indexed and searchable by the system.

In some cases, an issue tracking system may be used to assign work within an organization and/or to track completion of work, a ticketing system may be used to track issues, track compliance with service level agreements, and so on. As described with respect to examples provided herein, an issue tracking system can manage various issues or tasks that are processed in accordance with an automated workflow. The workflow may define a series of states that the issue or task must traverse before being completed.

In some cases, the issue tracking system may define projects, which can be used to manage and organize a group of interrelated issues. For example, a project may be a data type (e.g., a container data structure) within the issue tracking system used to organize and track a collection of issues related to a specific team, product, or service. A project can allow a team to manage their work by assigning tasks and/or issues, following workflows, and monitoring progress for a set of related issues. A project may also define the active fields or attributes of issues within the project and may also define a default set of workflows that are available for that project.

Typically, issue parameters, attributes, and/or other issue data is defined for a given issue when the issue is created at the issue tracking system. An issue may include issue parameters or attributes that define relationships to other issues. For example, a particular issue may be dependent on completion of one or more other issues. In this example, work, automations or other tasks for the particular issue may not be initiated until completion of the one or more other issues. If a project has additional issues that depend on the particular issue, these issues all need to be created at the issue tracking system. For large complex projects this may require creating large numbers of inter-dependent issues, prior to the initiation of the project and/or many of the issues defining the project. Accordingly, if one issue is changed (e.g., removed), all the issues that depend on the changed issue may need to be modified. Further some actions at an issue tracking system rely on cross-project collaboration and data sharing. Since projects are typically organized around a specific team, configuring cross-project permissions and data sharing between projects can greatly increase the complexity of configuring issues to share data, increase the complexity of coordinating issues across different projects and teams, and so on.

The orchestration system described herein can be used to generate orchestration process flows, which define the creation of issues, dependencies of issues, and data sharing between issues prior to creation of the project(s) and/or corresponding issues at the issue tracking system. The orchestration process flow can increase the efficiency of the issue tracking system, data sharing and/or associated permissions by defining the creation, dependencies and/or data sharing between issues prior to the issue creation. Further, the orchestration process flow can include data that is used to generate issues, dependencies between issues, data sharing and/or other parameters. Accordingly, an orchestration process flow can be used to coordinate project and/or cross-project collaborations prior to creating the issues that support these projects.

Additionally, the orchestration process system can be configured to track project and/or cross-project status. For example, the orchestration process system may display issue creation status that indicates which issues in an orchestration process flow have been created, which issues have not been created, a current status of the orchestration process flow, and the status conditions that will trigger the creation of specific issues.

The orchestration process system can be configured to generate an orchestration system user interface which can be used to generate an orchestration process flow. Once created, the orchestration process system can execute an orchestration process flow and cause creation of projects and issues at an issue tracking system using the project and issue parameters defined by the orchestration process flow.

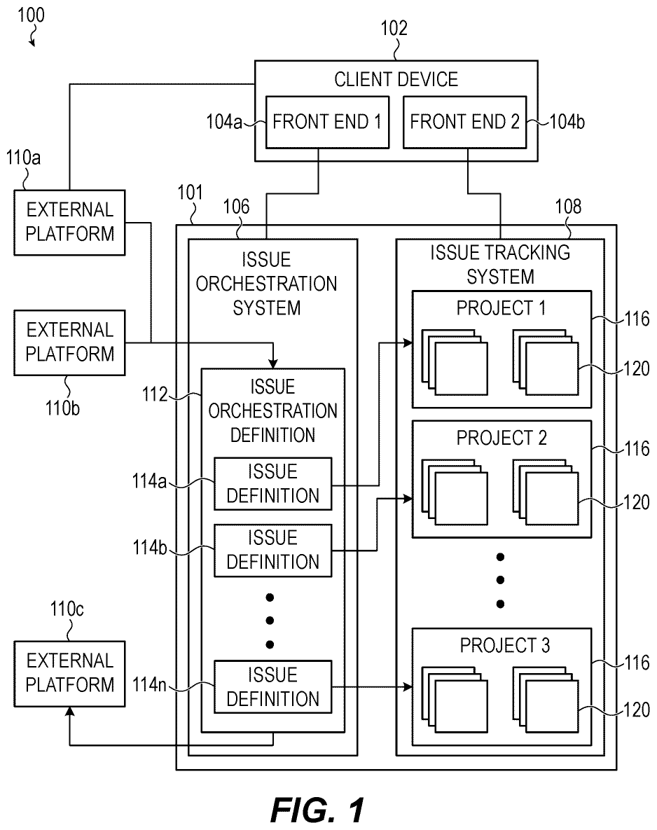

These foregoing and other embodiments are discussed below with reference to FIGS. 1-12. The detailed description given herein with respect to these figures is for explanation only and should not be construed as limiting.

FIG. 1 depicts an example of a system 100 for implementing cross-product orchestration process, as described herein. The system 100 can include one or more client devices 102, an issue orchestration system 106, an issue tracking system 108 and one or more external platforms 110. The system 100 is depicted as implemented in a client-server architecture, but it may be appreciated that this is merely one example and that other communications architectures are possible.

In particular, the system 100 includes a set of host servers 101 which may be one or more virtual or physical computing resources (collectively referred in many cases as a “cloud platform”). In some cases, the set of host servers 101 can be physically collocated or in other cases, each may be positioned in a geographically unique location. The set of host servers 101 can be communicably coupled to one or more client devices; an example client device is shown as the client device 102. The client devices 102 can be implemented as any suitable electronic device. In many embodiments, the client devices 102 is a personal computing device such as a desktop computer, laptop computer, or mobile phone.

The set of host servers 101 support infrastructure for one or more backend applications, each of which may be associated with a particular software platform, such as the issue orchestration system 106 (which may also be referred to and include a “first platform backend” 106) or the issue tracking system 108 (which may also be referred to and include a “second platform backend” 108). A portion of the set of host servers 101 can be allocated as physical infrastructure supporting a first platform backend (e.g., for the issue orchestration system 106) and a different portion of the set of host servers 101 can be allocated as physical infrastructure supporting a second platform backend (e.g., for the issue tracking system 108).

The first platform backend 106 can be configured to communicably couple to a first platform frontend 104a instantiated by cooperation of a memory and a processor of the client device 102. Once instantiated, the first platform frontend 104a can be configured to leverage a display of the client device 102 to render a graphical user interface so as to present information to a user of the client device 102 and so as to collect information from a user of the client device 102. The second platform backend 108 can be configured to communicably couple to a second platform frontend 104b instantiated by cooperation of a memory and a processor of the client device 102. Once instantiated, the second platform frontend 104b can be configured to leverage a display of the client device 102 to render a graphical user interface so as to present information to a user of the client device 102 and to collect information from a user of the client device 102.

The first platform frontend 104a can be configured to communicate with the first platform backend 106. Information can be transacted by and between the client device 102 and the set of host servers 101 in any suitable manner, form or format. In some embodiments, the client device 102 and in particular the first platform frontend 104a can be configured to send an authentication token along with each request transmitted to any of the first platform backend 106. The second platform frontend 104b can be configured to communicate with the second platform backend 108. Information can be transacted by and between the client device 102 and the set of host servers 101 in any suitable manner, form or format. In some embodiments, the client device 102 and in particular the second platform frontend 104b can be configured to send an authentication token along with each request transmitted to any of the second platform backend 108.

The issue orchestration system 106 can be configured to define issue orchestration process flows (also referred to as an “orchestration definition 112”), and execute the orchestration definitions to cause the corresponding issues to be created at the issue tracking system 108. The issue orchestration system 106 can be configured to interface with one or more external platforms 110 using any suitable communication protocols. The issue orchestration system 106 may receive and/or transmit data from one or more of the external platforms 110.

The issue orchestration system 106 may also receive and/or transmit requests with one or more of the external platforms. For example, a first external platform 110a may be a human resource-based platform that manages human resource activities such as onboarding, payroll, time tracking, and so on. The issue orchestration system 106 can be configured to receive notifications and/or other data from the first external platform 110a, for example, in response to specific events occurring at the first external platform 110a. For example, the issue orchestration system 106 can be configured to receive a notification when a new employee is entered into the first external platform 110a and may also receive information associated with the new employee from the external platform 110a. The received information may include information that is used by the orchestration system 106 to initiate an orchestration process flow and/or be used as inputs to an orchestration definition 112 or to create and mange corresponding issues created from an orchestration definition 112.

The external platforms 110 can be any suitable third-part software services and/or other software products. As another example, a second external platform 110b may be a messaging system. The orchestration system 106 can be configured to receive notifications and/or other data in response to specific events occurring at the messaging system. For example, in response to specific commands being identified in a messaging session, the orchestration system 106 can receive a notification of the commands and/or other data, which may be used to initiate an orchestration process flow, may be used as inputs to an orchestration definition 112 and/or used to generate a new orchestration process flow.

In some cases, the issue orchestration system 106 may send notifications, data and/or other communications to one or more of the external platforms 110. For example, the orchestration process system 106 may be configured to send notifications and/or data to a third external platform 110c in response to a specific event(s). For example, the orchestration process system 106 may send a status update indicating the initiation of a specific orchestration process flow and/or the creation of one or more issues to the third external platform 110c.

The issue orchestration system 106 can be configured to provide a user interface for creating orchestration definitions 112 and be configured to cause the orchestration definitions 112 to be executed. Each orchestration definition 112 can include a set of dependent issue definition blocks 114, which can include one or more issue parameters which are used to generate an issue at the issue tracking system 108. The orchestration definition 112 can define dependencies of the issue definition blocks 114, which can be used to define a dependency between the respective issues as they are created at the issue tracking system 108. Additionally, the orchestration definition 112 can define issue creation conditions, which define the one or more conditions that trigger creation of the issue at the issue tracking system 108.

Each issue orchestration definition 112 may include multiple dependent issue definition blocks 114 that collectively define an orchestration process flow that when carried out causes the corresponding projects and/or issues to be created at the issue tracking system 108. For example, the orchestration definition 112 can include a first issue definition 114a that includes one or more first issue parameters that are used to generate a first issue at the issue tracking system 108; a second issue definition 114b that includes one or more second issue parameters that are used to generate a second issue at the issue tracking system 108; and so on. Each issue definition 114 can be a data structure that stores the issue parameters (issue data), prior to creation of the issue at the issue tracking system. Each issue definition 114 can store a variety of issue data and different issue definitions 114 can store different issue parameters. For example, the issue definitions 114 can store an issue name, description, an issue type, a defined workflow for the issue, dynamic data values that are retrieved from other systems or an external platform, an assignee, and so on. Accordingly, as a respective issue is created at the issue tracking system, the issue parameters stored in the issue definition 112 can be used to populate the issue fields as part of the issue creation process.

The issue tracking system 108 can be configured to generate and manage issues to assist with a problem or other tasks. In some cases, the issue tracking system 108 may define projects 116, which can be used to manage and organize a group of interrelated issues 120. For example, a project 116 may be a data type (e.g., a container data structure) within the issue tracking system 108 used to organize and track a collection of issues 120 related to a specific team, product, or service. A project 116 can allow a team to manage their work by assigning tasks and/or issues 120, following workflows, and monitoring progress for a set of related issues.

An issue 120 can be associated with issue data, which may include a variety of information including a request type, an issue title, a summary of the issue input by a requesting user, and/or other information that is created at the time of the issue. The issue tracking system 108 may also associate other types of data with the issue, which may include workflow data. The workflow data may define a series of states that the issue 120 or task must traverse before being completed. The issue tracking system 108 may also track user interaction events (e.g., messages), issue state transitions, automations associated with the issue and other events that occur over the lifecycle of the issue, which may be indexed and searchable by the system. In some implementations, the issue is automatically processed in accordance with the states defined in the workflow, as tasks are completed, or state criteria are satisfied.

The system 100 can manage user access and sharing of orchestration process flows, issues, projects and/or other content managed by the system. For example, the system can manage access to issue definition blocks and the corresponding issues for individual users of a system. User accounts associated with a user may be configured with defined access permissions, which may be used by the system to determine which electronic data, and/or specific content within an orchestration process flow and/or issue, can be accessed and/or modified by a particular user account. The system 100 can manage access to issues and/or specific issue attributes based on user account permissions associated with the corresponding electronic data. For example, user accounts can have access permission that allow a user to view a particular orchestration process flow, issue definition block, subset of information within an issue definition block and/or corresponding issue data.

In some cases, the system 100 manages different permissions for different users. For example, some users may be assigned administrator privileges, which may give them more access to electronic content, such as the ability to edit, delete, structure/organize, format, or otherwise manipulate orchestration process flow and/or issues associated with other users of the system. For example, a permissions profile of an authenticated user (e.g., a role or other user profile data) may be evaluated with respect to permissions for a particular content item like an orchestrion process flow and/or particular issue definition blocks. A user having a permissions profile that is consistent with the permissions of a content item may be permitted to view, edit, or perform other actions with respect to the content item. The system 100 may be configured to authenticate a user of a client device 102 in response to successfully authenticating or verifying user credentials, which may be received via the frontend 104 or may be received from another trusted system or service that may manage user credentials and authentication for a variety of software platforms. The user credentials may include a name and password, authentication token, or other data that can be used to verify and authenticate a system user.

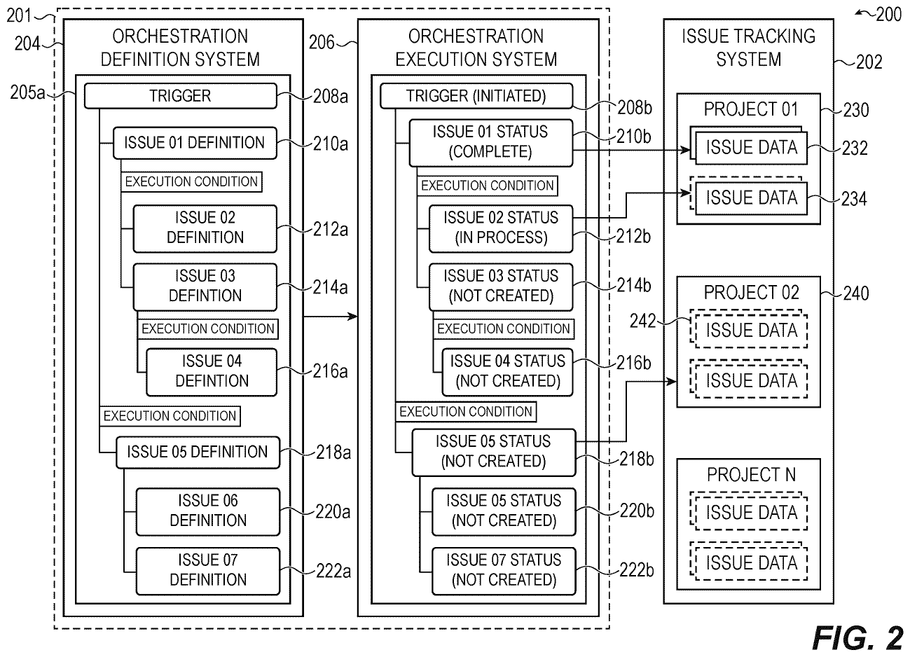

FIG. 2 depicts a diagram of system 200 including a cross-project issue orchestration system 201 and an issue tracking system 202. The issue orchestration system 201 and the issue tracking system 202 can be examples of the issue orchestration systems (e.g., issue orchestration system 106) and issue tracking systems (e.g., issue tracking system 108) described herein. The issue orchestration system 201 can include an orchestration definition system 204, which can be used to generate orchestration process flows and an orchestration execution system 206, which can be configured to cause execution of the orchestration process flows and cause projects and issues to be created at the issue tracking system 202.

The orchestration definition system 204 depicts an example of an orchestration process flow 205a (also referred to herein as an orchestration definition). The orchestration process flow 205 can be generated at the orchestration system 201, using an orchestration system user interface, as described herein. The orchestration process flow 205 can include issue definition blocks that define one or more projects and/or issues, a dependency of the projects and issues, and/or creation conditions for initiating creation of the projects and issues, as described herein.

The orchestration process flow 205 can include a trigger object 208a, which can define conditions that cause initiation of the orchestration process flow. In some cases, the trigger object 208a can define one or more trigger conditions based on communications from an external application platform, as described herein. For example, the one or more trigger conditions can include particular actions that have occurred at an external application. In response to receiving data, an alert or other communication from the external application indicating the occurrence of the particular action (e.g., a new employee created at an external application, a command identified in a messaging application, etc.) and satisfying the one or more trigger conditions, the orchestration system 201 can be configured to initiate the orchestration process flow 205.

The orchestration process flow 205 can include issue definition blocks. The issue definition blocks can include a first issue definition block 210a, which defines a first project 230. The orchestration process flow 205 can include multiple issue definition blocks which depend on the first issue definition block 210a, and that are used to create issues 232, 234 that are part of the first project 230. For example, a second issue definition block 212a, and a third issue definition block 214a can each depend on the first issue definition block 210. Additionally, a fourth issue definition block 216a can depend on the third issue definition block 214a.

The issue definition blocks can include a fifth issue definition block 218a, which defines a second project 240. The orchestration process flow 205 can include multiple issue definition blocks which depend on the fifth issue definition block 218a, and are used to create issues 242 that are part of the second project 240. For example, a sixth issue definition block 220a and seventh issue definition block 222a can each depend on the fifth issue definition block 218a.

In response to determining the occurrence of one or more trigger conditions defined by the trigger object 208a, the orchestration execution system 206 can be configured to cause execution of the orchestration process flow 205a. Once triggered, the orchestration execution system 206 can generate a unique instance of an orchestration process for a corresponding orchestration process flow 205a. For example, execution of the orchestration process flow 205a can cause a first instance of the orchestration process flow 205b to be created at the issue orchestration system 201. Each time, the issue orchestration system 201 determines that the one or more trigger conditions are satisfied, the issue orchestration system 201 can cause a new instance of the orchestration process flow 205b to be created. Accordingly, a single orchestration process flow 205a can result in multiple unique execution instances of the orchestration process flow.

The first instance of the orchestration process flow 205a can be used to track the execution of the first instance of the orchestration process flow 205b. The first instance of the orchestration process flow 205b provides an example of a partially executed orchestration process flow. For example, the first instance of the orchestration process flow 205b includes an updated trigger object 208b, which indicates that the one or more trigger conditions have been satisfied. Additionally or alternatively, the updated trigger object 208b may store data received from an internal or external platform, which can include communications/data that corresponds to the trigger conditions and/or other data received from the internal or external platform and used as inputs to the orchestration process flow 205.

The first instance of the orchestration process flow 205b includes an updated first issue definition block 210b, which indicates that the corresponding first project 230 has been created at the issued tracking system 202. The updated first issue definition block 210b can store status information indicating the creation of the first project 230, which may be based on data or other communications received from the issue tracking system 202 in response to the first project 230 being created at the issued tracking system 202.

The first instance of the orchestration process flow 205b includes an updated second issue definition block 212b, which indicates that the creation of the corresponding second issue at the issued tracking system 202 has been initiated, but not completed. The updated second issue definition block 212b can store status information indicating partial creation of the second issue data 234, which may be based on data or other communications received from the issue tracking system 202.

The first instance of the orchestration process flow 205b includes an updated third issue definition block 214b, an updated fourth issue definition block 216b, which indicate that the creation of the corresponding second issue at the issued tracking system 202 has not been initiated. Accordingly, the corresponding issue data has not been created at the issue tracking system.

The first instance of the orchestration process flow 205b includes an updated fifth issue definition block 218b, an updated sixth issue definition block 220b, and an updated seventh issue definition block 222b, which indicate that the creation of the corresponding second project 240 and the corresponding issues 242 at the issued tracking system 202 have not been initiated.

As issues are generated in accordance with an issue definition block as part of executing an orchestration process flow, the definition block can cause dynamic variables (e.g., smart variables) to be passed to an issue and/or shared across projects. Dynamic variables can be dynamic objects which store data variables that may change over time. In some cases, dynamic variables may reference other issues, changes from external application platforms, data stored in other projects, data stored in other systems, and so on. The system can be configured to retrieve the data or other values associated with a smart variable when the issue is created, or when the variable is required from some process, such as performing an automation or passing information to other related issues.

In some cases, an issue tracking system can be configured to create different types of issues and/or different types of service requests. For example, the issue tracking system can include various issue types, which can include pre-defined templates that categorize and organize work, and are used to track different types of issues. Issue types can be configured as templates for different kinds of work within a project, allowing a user to classify and manage tasks, bugs, and other issues types. The issue tracking system can be configured with default issue types for projects and teams. Users can also configure new issue types for specific types of projects. Issue types can include a task, which represents work that needs to be done and a subtask, which can be a piece of work that is required to complete a task. Other examples of issue types can include a change, requesting a change in the current profile; a new feature, requesting a new capability or software feature; and so on.

In some cases, the issue tracking system can include a service management platform, that helps teams manage service delivery, including requests to resolutions, by providing a centralized platform for tracking, managing, and resolving customer requests, incidents, and problems. A service request management platform can be configured to receive user submitted request, and manage and track completion of those requests. For example, service requests include requests for access to applications, software licenses, password resets, or new hardware. New services request can be associated with specific request types. For example, a request type may be an information technology (IT) request type, another request type may be a request specific to a particular team (e.g., sales team), and so on. In some cases, the request type may define what type of information/attributes are received as part of the request, automations for processing the request, and/or other attributes, as described herein.

An issue definition block can be configured to generate issues using specific issue types and/or specific request types. In some cases, in response to designating a particular issue type and/or request type, the issue definition block may be configured with particular fields/attributes for the selected issue type or request types and be configured with selectable dynamic values associated with the selected issue type or request type.

Additionally or alternatively, the issue definition blocks can be configured to references, pull information, or link to other collaborative systems such as a collaborative document system, a project management system, a code hosting system, and so on. For example, a definition block can be added to an orchestration process for creating a specific collaborative document in an document management system, which can cause the collaborative document to be created at the document management system. For example, a definition block can be configured to create a new user checklist collaborative document at the document management system, which can be a collaborative document including checklist items for a new user to complete. Similarly, a definition block can be used to create or pull data from a project management system. Additionally or alternatively, execution conditions or other conditional elements may pull data from a project management system, which may be used to condition execution of other definition blocks.

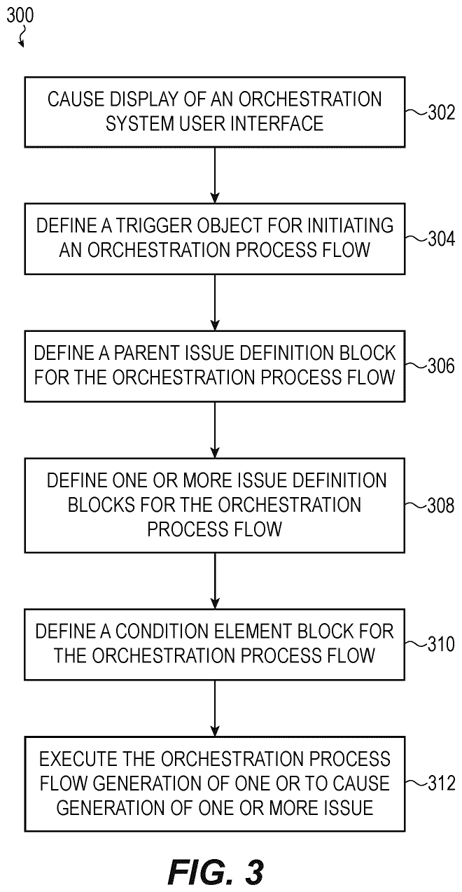

FIG. 3 depicts an example process 300 for defining and executing a cross-product orchestration process. The process 300 can be performed by the systems described herein including systems 100 and 200.

At operation 302, the process 300 can include causing display of an orchestration system user interface. The orchestration system user interface can include a rule-library panel defining one or more issue definition blocks and a rule-generation panel configured to receive issue definition blocks and define a dependent relationship between one or more of the issue definition blocks. The orchestration user interface allows a user to generate one or more orchestration process flows by adding issue definition blocks to the rule-generation panel, defining issue parameters for each issue definition block, defining logic conditions for each issue definition block, defining dependencies between the issue definition blocks, and so on, as described herein.

At operation 304, the process 300 can include defining a trigger object for initiating an orchestration process flow. The trigger object can be displayed in the rule-generation panel as part of configuring the orchestration process flow. The trigger object can be configured to cause the system to receive data from an external application platform and define one or more trigger conditions based on the received data. In some cases, the parameters available for a trigger object can be based on services provided by the external application (e.g., through an application programming interface (API). Accordingly, different trigger conditions may be defined for one or more external application platforms, and be based on data, notifications or other communications provided by a respective external platform.

At operation 306, the process 300 can include defining a first issue definition block for an orchestration process flow. The first issue definition block can be displayed in the rule-generation panel as part of configuring the orchestration process flow. The first issue definition block can define one or more issue parameters that are used to generate a parent issue at an issue tracking system, as described herein. In some cases, generation of the first issue is initiated by the one or more creation conditions, which may be defined as part of the issue definition block.

At operation 308, the process 300 can include defining one or more additional issue definition blocks for the orchestration process flow. The one or more additional issue definition blocks can each be displayed in the rule-generation panel. Each issue definition block can have a dependent relationship to one or more of the other issue definition blocks and include issue data used to generate a respective issue at the issue tracking system. The dependent relationships between issue definition blocks can be used to define a corresponding dependent relationship between the respective issues at the issue tracking system.

At operation 310, the process 300 can include defining a condition element block for the orchestration process flow. The condition element block can be displayed in the rule-generation panel as part of generating the orchestration process flow. The condition element block can connect issue definition blocks and define one or more conditions for initiating the creation of the second issue at the issue tracking system. In some cases, condition elements can be added to the rule-generation panel based on user inputs to the orchestration system user interface. For example, a user may add a condition element directly to the rule-generation panel, which may include interface elements that allow a user to input one or more parameters that define creation parameters at the issue definition block that initiates creation of the corresponding issue.

At operation 312, the process 300 can include executing the orchestration process flow to cause generation of one or more issues at the issue tracking system. For example, the orchestration process system may receive and/or retrieve notifications or other data from an external application platform (or internal application platform) and evaluate the retrieved/received data to determine whether a trigger condition of the orchestration process flow is satisfied. In response to determining that one or more trigger conditions for an orchestration process flow have been satisfied, the orchestration process system can cause the orchestration process flow to be executed and issues to be created at the issue tracking system, as described herein.

In some cases, as issues are created at the issue tracking system, the execution process flow can cause the issues to be attributed, assigned to and/or created on behalf of one or more registered user accounts for the issue tracking system. In some cases, the execution process flow may associate a user account(s) with one or more of the issue definition blocks and execution of an issue definition block can cause the issue to be associated with the associated user. In some cases, a user account can be associated with an orchestration process flow, and each issue created as a result of executing the orchestration process flow can be attributed/associated with the designated user account. In other cases, one or more issue definition blocks can each be associated with a particular user account and execution of an issue block can cause the particular user account to the associated with the created issue.

In some cases, a first issue definition block can be configured to cause generation of a new user account at the issue tracking system. The orchestration process flow can utilize dynamic parameters at dependent issue definition blocks to utilize the new user account once created. Accordingly, execution of the dependent issue definition blocks can be conditioned on completion of the first issue definition block and utilize the dynamic parameter (e.g., newly created user account) as input (e.g., an assignee) of the dependent issue definition blocks.

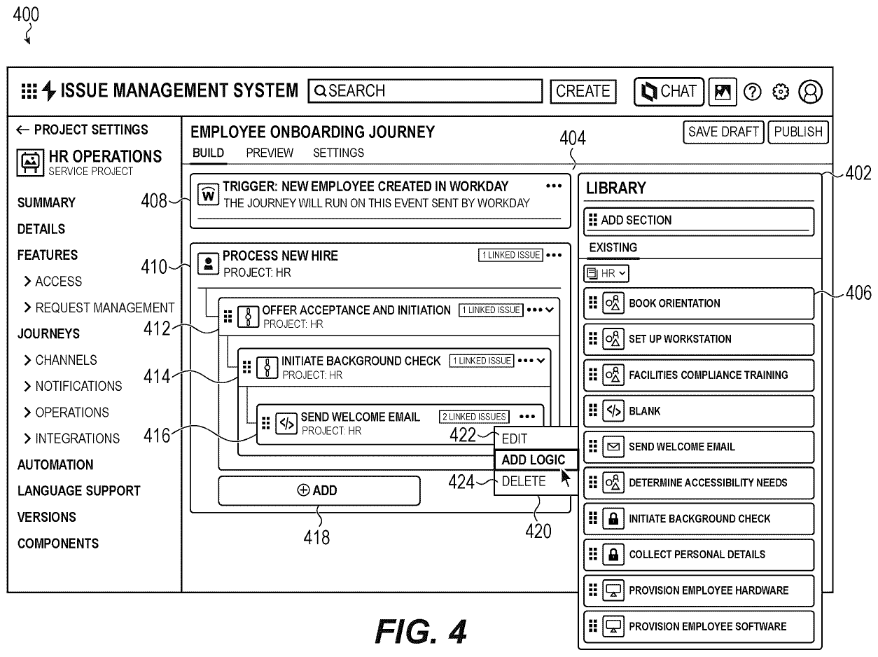

FIG. 4 depicts an example orchestration system user interface 400 for generating a cross-product orchestration process. The orchestration system user interface 400 can be generated by the systems described herein including the orchestration system and be displayed at a client device authenticated with respect to a particular user account.

The orchestration system user interface 400 can include a rule-library panel 402 that includes one or more preconfigured issue definition blocks 406 (one of which is labeled). The orchestration system user interface 400 can also include a rule-generation panel 404 that is configured to receive issue definition blocks and define dependent relationships between one or more of the issue definition blocks. In some cases, the pre-configured issue definition blocks 406 can be added to the rule-generation panel 404 (e.g., using drag-and-drop operations). In other cases, issue definition blocks can be generated by a user, for example, using selectable element 418 to add a new issue definition block to the rule-generation panel 404.

The preconfigured issue definition blocks 406 can include data objects that are configured for a particular functionality. For example, the preconfigured issue definition blocks 406 may have preconfigured parameters such as a title, description, issue parameters, issue types and so on. In these examples, once a preconfigured issue definition block 406 is added to the rule generation panel 404, the pre-configured parameters may include dynamic data objects that cause the corresponding issue definition block to be populated with data upon execution of a specific instance of the orchestration process flow. In some cases an issue definition block can be added directly to the rule-generation panel 404. For example, selectable element 418 can be configured to cause creation of a new issue definition block in the rule-generation panel 404. A new issue definition block (e.g., created using selectable element 418) may not have preconfigured parameters and a user of the system may define the parameters from the new issue definition block.

In some cases, preconfigured issue definition blocks 406 can be ordered based on one or more parameters such as a defined organizational team definition, based on a particular use of each block, and/or dynamically displayed according to other parameters. Additionally or alternatively, the issue definition blocks 406 may include graphical elements that indicate a type of issue or other preconfigured issue attributes associated with each block. The graphical elements can include text, colors, icons (or other images) and so on.

In some cases, issue definition blocks (e.g., issue definition blocks 406) can be configured to be moved from the rule-library panel 402 and to the rule-generation panel 404 using drag-and-drop functionality, and/or any other types of user inputs. In some cases, the rule-library panel 402, can be configured to place the issue definition blocks in various pre-defined orientations with respect to other issue definition blocks. For example, the user interface may cause an issue definition block to snap to a first location that has a same root node location as another issue definition block, which may be used to visually indicate that the issue definition blocks have a same hierarchical level (e.g., both are project definition blocks). Additionally or alternatively, the user interface can cause an issue definition block to snap to an indented/first level node location with respect to an adjacent issue definition block, which may be used to visually indicate that the issue definition block is dependent from the adjacent issue definition block.

In the example shown in FIG. 4, the rule-generation panel 404 includes a trigger object 408, a first issue definition block 410, a second issue definition block 412, a third issue definition block 414, and a fourth issue definition block 416. The trigger object 408 can be an example of the trigger objects described herein and define one or more trigger conditions for initiating the orchestration process flow defined by the issue definition block in the rule-generation panel 404. In some cases, the trigger object 408 can be configured with one or more trigger conditions that are based on information generated by an external application platform, as described herein. The trigger object 408, when the corresponding orchestration process flow is executed, can cause the orchestration system to receive communications from the external application platform and evaluate the received communications to determine whether the one or more trigger conditions are satisfied.

Each issue definition block can be independently configured and an arrangement of the issue definition blocks within the rule-generation panel 404 can be used to define dependencies between the corresponding issues when they are created at the issue tracking system. In the example shown in FIG. 4, the first issue definition block 410 represents a parent issue for the entire orchestration process flow and the other issue definition blocks each depend on the first issue definition block 410. Accordingly, as a first issue is generated at the issue tracking system based on the first issue definition block 410, the first issue will be linked to each of the dependent issues as they are created. For example, the second issue definition block 412 is dependent on the first issue definition block, and when a second issue is generated at the issue tracking system based on the second issue definition block 412, the second issue will be generated with a dependent relationship to the first issue. Additionally, the orchestrations system can cause the first issue to be updated at the issue tracking system to include this dependent relationship.

The dependent relationships of the issue definition blocks can be visually represented using the nodal structure of the issue definition blocks. For example, the second issue definition block 412 is displayed as a box that is linked to the first issue definition block 410. In some cases, lines, indents, or other visual indicators can be used to display the dependent relationships.

The third issue definition block 414 can depend on the second issue definition block 412, and the fourth issue definition block 416 can depend on the third issue definition block 414. The dependent relationship of the issue definition blocks can be defined for each dependent pair. For example, in some cases, the dependent relationship can be used to control initiation of each corresponding issue, data shared between issues and so on. As one example, a dependent issue may not be created until completion of the issue that it depended from. In other cases, issue definition blocks, including dependent issue definition blocks may be processed in parallel unless a condition element, defining conditions for execution of a downstream or dependent issue, is defined. Accordingly, the dependent relationships defined between the issue definition blocks can be used by the system to control conditions under which each new issue is created and/or issue parameters and data used to create that issue.

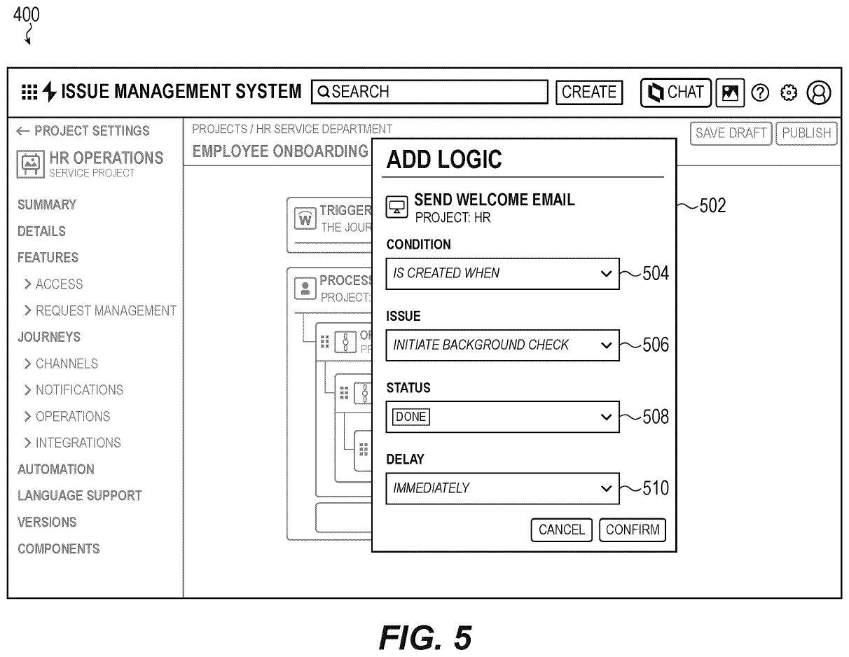

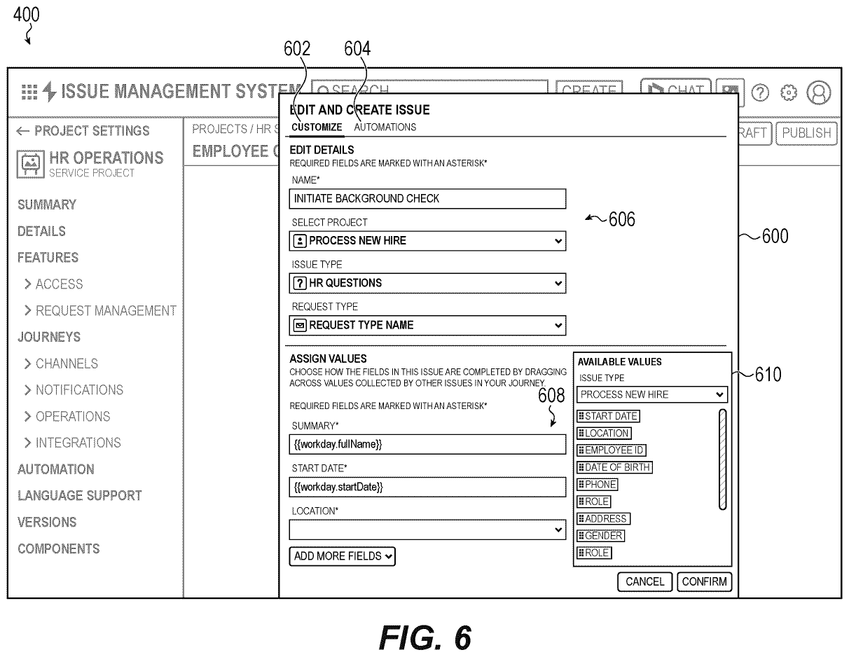

Each issue definition block can include a control element that can be used to configure parameters of the respective issue definition block. The fourth issue definition block 416 shows an example of a control element 420 that can be used to configure parameters for the fourth issue definition block. The control element 420 can include a first option 422 to edit parameters of the fourth issue definition block 416, and selection of the first option 422 can cause the system to display an editing interface (e.g., editing interface 600 shown in FIG. 6). The control element 420 can include a second option 424 to define logic parameters of the fourth issue definition block 416, and selection of the second option 424 can cause the system to display a logic interface (e.g., logic interface 502 shown in FIG. 5).

FIG. 5 depicts an example logic interface 502 used to define a logic parameter for an issue definition block. In some cases, the logic interface 502 can be displayed as a window within the orchestration system user interface 400 (e.g., over the rule-library panel and/or the rule-generation panel). The logic interface 502 can be configured to define one or more logic parameters/conditions for initiating creation of the corresponding issue at the issue tracking system. That is, the logic parameters are associated with a particular issue definition block (e.g., the fourth issue definition block 416) and define conditions that need to be satisfied to cause the generation of the corresponding issue at the issue tracking system.

In some cases, the logic parameters/logic criteria may be defined at a particular location within the orchestration process flow and define one or more criteria that needs to be satisfied before the orchestration process flow will progress to a next action, such as execution of a downstream issue definition block.

The logic interface 502 can include a first field 504 that causes the creation of the issue to be dependent on a defined condition. The logic interface 502 can include a second field 506 that defines a first parameter for the defined condition. For example, the second field 506 can define that the creation of the issue is dependent on another issue (e.g., the creation of a fourth issue, corresponding to the fourth issue definition block 416, is dependent on a parameter of a third issue corresponding to the third issue definition block 414). The logic interface 502 can include a third field 508 that defines a second parameter for the defined condition. For example, the fourth issue definition block is executed to cause creation of the fourth issue when a status of the third issue (corresponding to the third issue definition block 414) has a value of “done.” In some cases, the logic interface 502 can include a fourth field 510 that defines a fourth parameter for the defined condition. For example, the fourth parameter can define when the corresponding issue is created (e.g., immediately, after a defined period of time, and so on).

In some cases, a given issue definition block may include multiple dependent conditions for creating the corresponding issue. For example, the system may configure a first set of conditions using a first instance of the logic interface and a second set of conditions using a second instance of the logic interface. In these examples, the issue definition block may not be executed to cause creation of the corresponding issue until all conditions are satisfied.

FIG. 6 depicts an example editing interface 600 used to define one or more issue parameter for an issue definition block. In some cases, the editing interface 600 can be displayed as a window within the orchestration system user interface 400 (e.g., over the rule-library panel and/or the rule-generation panel). The editing interface 600 can be configured to define one or more issue parameters, issue definitions, issue attributes and/or store issue data that is used to generate the corresponding issue at the issue tracking system. That is, the issue parameters are associated with a particular issue definition block (e.g., the fourth issue definition block 416) and define issue parameters and data that are input into the issue fields to cause the generation of the corresponding issue at the issue tracking system.

The editing interface 600 can include an issue parameter tab 602 that causes display of one or more fields that can be used to define issue parameters. For example, a first set of fields 606 can be used to store issue data such as a name of the issue, a project/team that the issue will be associated with, an issue type, a request type, and so on. The parameters from these fields will be stored as part of the issue definition block or in association with the issue definition block and used to create the issue at the issue tracking system. Accordingly, the issue definition block allows issue parameters to be defined prior to creation of an issue and allows those parameters to be stored until the issue creation is triggered.

The issue parameters can also include dynamic values 608 that are obtained from or can be used by other systems, issues, and/or projects. For example, the dynamic values 608 may include values that are retrieved at the time the issue is created and may be based on values that are received from other systems and/or may change over time. Accordingly, the dynamic values 608 may be configured for the issue at the time of issue creation and allow the issue to be dynamically updated as these values are updated. In some cases, the editing interface 600 can display a set of dynamic values 610 that can be defined for the corresponding issue definition block. In some cases, the set of dynamic values 610 may include values for linked issues (e.g., issues that the respective issue depends on), values from external platforms, and so on. Dynamic values/variables can be dynamic objects which store data variables that may change over time. In some cases, dynamic variables may reference other issues, changes from external application platforms, data stored in other projects, data stored in other systems, and so on. The system can be configured to retrieve the data or other values associated with a smart variable when the issue is created, or when the variable is required from some process, such as performing an automation or passing information to other related issues.

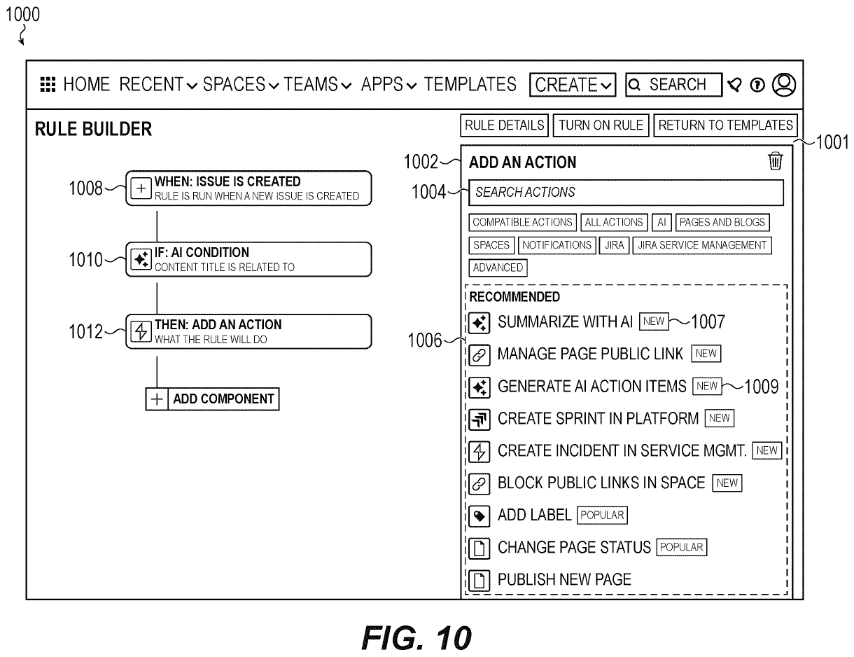

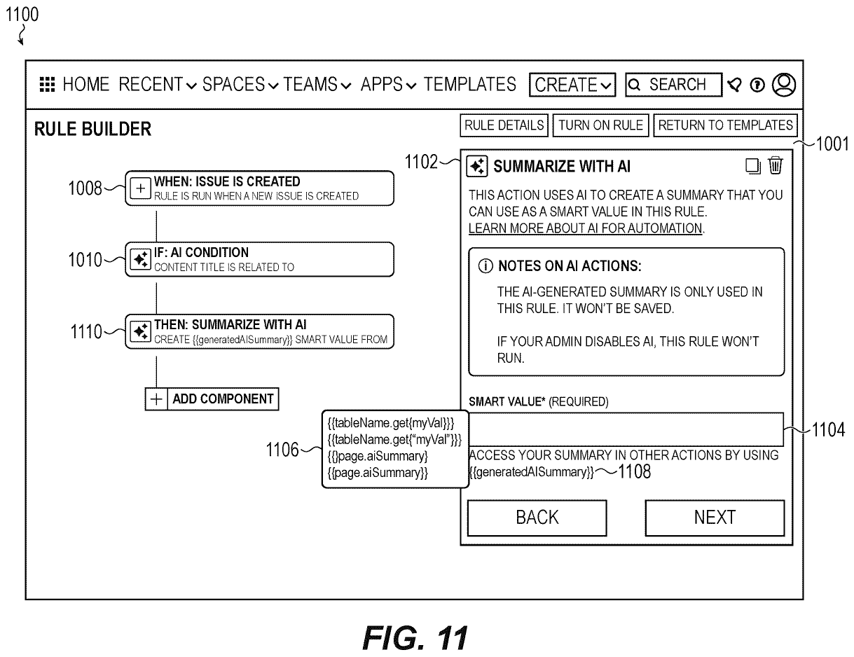

The editing interface 600 can include an automations tab 604 that causes display of an automations interface, which can be used to define one or more automations that will be generated for the corresponding issue. An example of an automations interface and/or automations that can be define for an issue definition block are described with respect to FIGS. 10-11.

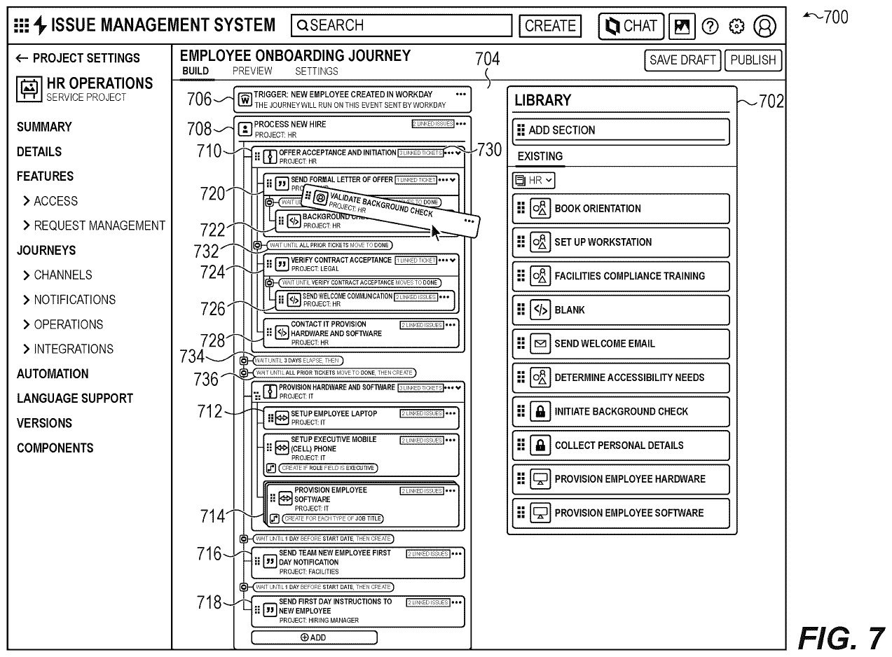

FIG. 7 depicts an example orchestration system user interface 700 for generating a cross-product orchestration process. The orchestration system user interface 700 can be generated by the systems described herein including the orchestration system and displayed at a client device authenticated with respect to a particular user account. The orchestration system user interface 700 can include a rule-library panel 702, and a rule-generation panel 704, which can be examples of the rule-library panels and rule-generation panels described herein.

The user interface 700 shows an example of an orchestration process flow defined in the rule-generation panel 704, and includes multiple dependent issue definition blocks. The issue definition blocks can be added to the rule-generation panel 704, as described herein, and moved (e.g., dragged) to different locations within the rule-generation panel 704. The movement of the issue definition blocks can be used to define the dependency of an issue definition block with respect to other issue definition blocks. For example, the rule-generation panel 704 can be configured to snap blocks to specific locations that indicate a dependency with respect to other issue definition blocks.

The orchestration process flow shown in the rule generation panel 704 includes a trigger object 706; multiple issue definition blocks 708, 710, 712, 714, 716, 718, 720, 722, 724, 726, and 728; a linked issue indicator 730; and multiple condition element blocks 732, 734, and 736, which may be examples of similar elements described herein. The orchestration process flow displayed in FIG. 7, is an example of an orchestration process flow for an employee onboarding process.

The trigger object 706 can be an example of the trigger objects described herein and define one or more trigger conditions that are evaluated by the system to initiate an instance of the orchestration process flow. In some cases, selecting the trigger object 706, in the rule-generation panel 704, can cause the system to display an interface for configuring the one or more trigger condition for the trigger object. For example, the interface may allow the trigger conditions to be based on actions/inputs from one or more external platforms, as described herein. In these examples, the interface may allow a user to select a particular external platform and then provide trigger conditions that are available/specific to the selected platform. For example, if the selected external platform is a human-resource platform a trigger condition may include the creation of a new employee at the external platform. Accordingly, each time a new employee is created at the external platform, the orchestration system may receive an indication of the creation of the new employee, which can trigger execution of an instance of the orchestration process flow. In some cases, if multiple new employees are created, the system may trigger the execution of multiple instances of the orchestration process flow, where each instance corresponds to a different employee. Accordingly, the orchestration system may perform multiple instances of an orchestration process flow.

Additionally or alternatively, the orchestration system may receive data from an external (or internal platform) that is used as part of executing an instance of the orchestrion process flow. For example, in response to initiating an orchestration process flow based on creation of a new employee, the orchestration system may receive employee information from the external platform. This information may be used to populate the issue definition objects, and/or retrieve information from other systems that is used as part of executing the orchestration process flow.

The multiple issue definitions blocks can include a first issue definition block 708, which can be a container structure for the orchestration process flow and each other issue definition block can depend on the first issue definition block 708. In some cases, the orchestration process flow can span multiple projects. For example, a second issue definition block 710 can correspond to a first project, a third issue definition block 712 can correspond to a second project. As described herein, the issue tracking system may define projects, which can be used to manage and organize a group of interrelated issues. For example, a project may be a data type (e.g., a container data structure) within the issue tracking system used to organize and track a collection of issues related to a specific team, product, or service. Accordingly, the orchestration process flow can define a relationship between the first project (e.g., defined by the second issue definition block 710) and the second project (e.g., defined by the third issue definition block 712), and be used to pass information or other data between the projects.

The second issue definition block 710 can include a set of dependent issue definition blocks, which are associated with the first project. For example, the set of dependent issue definition blocks can include a first dependent issue definition block 720, a second dependent issue definition block 722, a third dependent issue definition block 724, and a fourth dependent issue definition block 726. The second issue definition block 710 can include a linked issue indicator 730, which indicates the issues that depend on the second issue definition block. In some cases, as issue definition blocks are added to the rule-generation panel 704 causing dependencies to be defined, the linked issue indicator 730 can be updated to reflect changes to dependencies of the linked issued definition blocks.

The condition element blocks 732, 734, 736 can indicate conditions for creation of an issue corresponding to a linked issue definition block. For example, a first condition element block 732 links the third dependent issue block 724 to the second issue block 710 and defines conditions for executing the third dependent issue block 724 to cause creation of a corresponding issue at the issue tracking system. In some cases, the first condition element block 732 can be displayed in response to defining one or more logic parameters for an issue definition block, for example using logic interface 502. In other cases, the orchestration system user interface can be configured to allow a user to add a condition element block to the rule-generation panel (e.g., based on inputs to the connecting lines extending between issue definition blocks), which may cause a logic interface to be displayed. The logic interface may be populated with fields based on parameters from the linked issues. For example, a logic interface corresponding to the first condition element block 732, may include fields that are populated using parameters from the second issue definition block 710. Additionally or alternatively, the condition element blocks can indicate the conditions for creation of the linked issues. For example, the first condition element block 732, may include an indication the third dependent issue definition block 724 will be executed once the defined conditions are met (e.g., when all previous issue definition blocks have been executed and the corresponding issues have a status value indicating that they are complete).

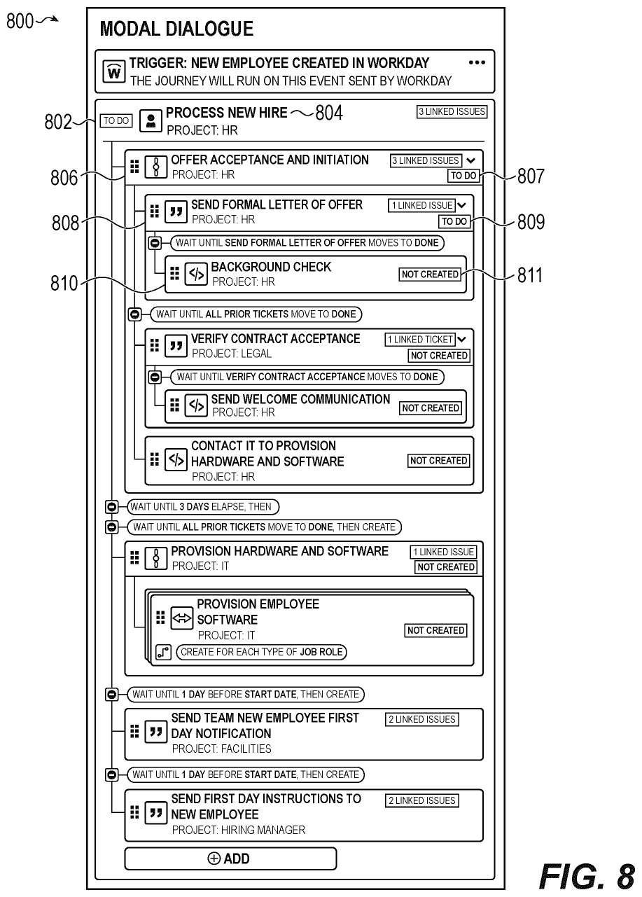

FIG. 8 depicts an example orchestration system user interface 800 including one or more status indicators for an orchestration process flow. The orchestration system user interface 800 can be generated by the systems described herein including the orchestration system and displayed at a client device authenticated with respect to a particular user account.

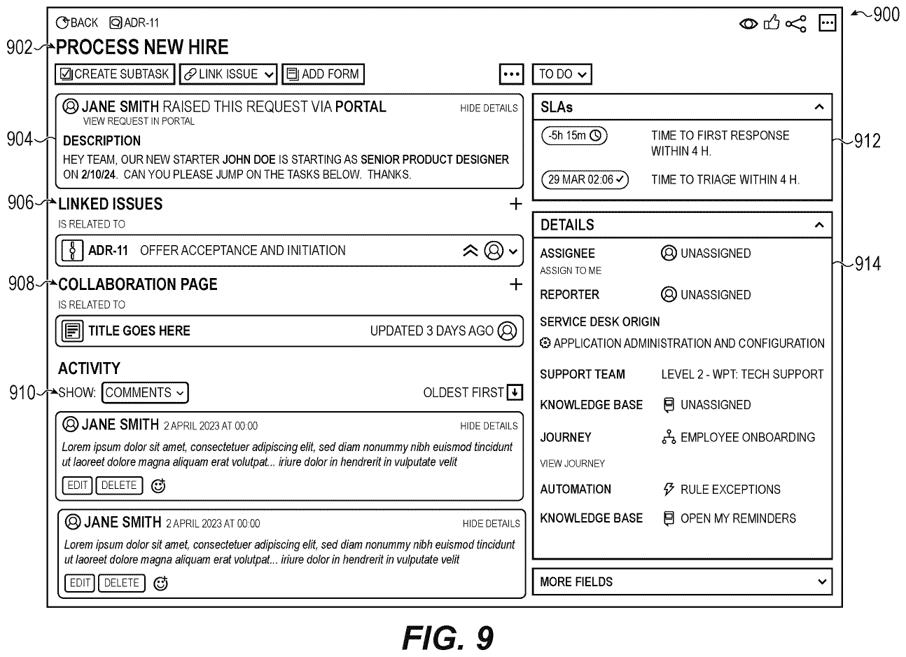

The orchestration system user interface 800 can be displayed in response to executing an instance of an orchestration process flow and comprise data and/or other information that is specific to a particular instance of orchestration process flow. For example, execution of the orchestration process flow can cause a first issue to be generated at the issue tracking system based on a first issue definition block 802. In response to the first issue being generated, the orchestrion system may display a link 804 to the first issue, and selection of the link 804 can cause the issue tracking system to display an issue view for the corresponding issue, an example of which is shown and described with respect to FIG. 9.

In some cases, the orchestration system can display status indicators 807, 809, 811 corresponding to issue definition blocks defined by the orchestration process flow. The status indicators can display an issue creation status at each issue definition block and can indicate a status of the corresponding issue at the issue tracking system. For example, a second issue definition block 806 can display a first status indicator 807, which indicates a status of the corresponding issue (e.g., “to do”). In the illustrated example, the “to do” status may indicate that the issue has been generated at the issue tracking system and is progressing, but the issue has not been completed yet. A third issue definition block 808 may include a second status indicator 809 indicating the corresponding issue has been created at the issue tracking system, but has not been completed. A fourth issue definition block 810 can include a third status indicator 811 indicating that the corresponding issue has not been created at the issue tracking system (e.g., the condition element (e.g., “wait until Send formal letter of offer move to Done”).

Additionally or alternatively, in response to an issue being created, the issue definition block can be updated to include a link to corresponding issues. For example, the title of the second issue definition block 806 can be updated to a link format which causes display of an issue view of the corresponding issue at the issue tracking system.

Additionally or alternatively, the system can generate other user interfaces for displaying information related to one or more orchestration process flows. In some cases, the system can create a summary interface summarizing information from one or more orchestration process flows. For example, a summary interface may include information related to a number of issues related to one or more orchestration process flows, numbers of each issue type created as part of one or more orchestration process flows, numbers of orchestration process flows that are active or have been executed and/or numbers associated with each type of active or executed orchestration process flow, and so on. In some cases, the system can create summary user interfaces for specific types of orchestration process flow. For example, the system may generate an interface showing information related to a specific type of orchestration process flow (e.g., all “onboarding” orchestration process flows, all offboarding orchestration process flows, and so on). The information may include information related to each execution instance of an orchestration process flow or type of orchestration process flow, information related to created issues from an orchestration process flow or type of orchestration process flow, and/or other suitable information.

In some cases, the system may generate a user interface that displays orchestration process flow information related to a specific project or other criteria. For example, the system may generate a user interface for viewing orchestration process flows related to a particular project. The user interface may show all orchestration process flows and/or include tools for displaying orchestration process flows based on specific criteria. For example, the interface may include options for displaying a particular type of orchestration process flows (e.g., all orchestration process flows that are associated with “onboarding” type). Additionally or alternatively, the user interface may display information related to the execution/progress of the orchestration process flows, such as a status for one or more of the issue definition blocks in each of the orchestration process flows, and/or provide links to a respective orchestration process flow, a respective issue at an issue tracking system and/or link to other content item manage by a collaborative system such as a document in a collaborative content system.

FIG. 9 depicts an example issue view 900 for an issue managed by an issue tracking system. The issue tracking system can display an issue and relevant information in the issue view 900. For example, the issue may include a title 902 (e.g., “Process new hire”), description 904, linked issues 906, links to other systems 908 (e.g., documents hosted by a collaboration platform), and an activity log 910. Additionally or alternatively, the issue view 900 can include information related to a service-level agreement (SLA) 912, which specifies the process, timelines, and metrics by which services, such as IT, are provided. The issue view 900 can include additional issue details 914.

The issue may be associated with the issue identifier or ticket in the issue tracking system. The issue tracking system may also gather other data (e.g., from user event logs or databases coupled to the issue tracking system). For example, upon generating an issue item, the issue tracking system may automatically set a time for reply and completion that may correspond to the SLA. An issue item may be assigned to particular service agents, an urgency of the request may be set, and the like. The issue may also include other fields which may be used by service agents to track metrics, add labels, track time, and the like.

The issue tracking platform may process each of the issues or tickets in accordance with a workflow or series of predefined states that the issue must traverse in order to be resolved by the issue tracking platform. When an issue is created, a workflow for resolving the issue is generated (e.g., via a backend application of the service management portal, such as the issue tracking system). As a first step, the issue may be assigned to a service agent or other users. In some embodiments, the request type and/or other fields from the intake interface may determine the assigning step. For example, a group of users may be assigned to particular intake categories. As another example, a group of users may be assigned to a project where the particular request type can be used. As yet another example, a particular data input to a field (e.g., “Process new hire”) may determine a user or a group of users to be assigned to the issue.

Once an issue item is assigned, the user or group of users assigned to the item may review the issue. On review of the issue, the assigned users may resolve the issue or may transfer the issue, as an example. Upon transferring, updated assignees may review the issue again to ensure proper routing of the issue item. In some cases, the issue may be canceled or it may be linked to another issue for a combined resolution. In some cases, depending on the complexity and/or the type of request, the workflow may include additional steps or less steps. More generally, the request type may dictate the number of steps and workflow used for each of the issue items.

FIG. 10 depicts an example frontend interface 1000 that supports automation rule creation and automated content assessment for an issue tracking system, in accordance with aspects described herein. Frontend interface 1000 may be displayed following selection by a user of an automation tab 604. Following selection, a condition selection window 1002 can be displayed adjacent the automation rule flow in the rule builder 1001. The automation rules can be configured to perform a series of operations or other manipulations on issues in response to one or more trigger conditions being met. In some cases, automations can be defined at the project level and in response to detecting a trigger condition, the system can be configured to perform an automation on one or more issues within the project. In other cases, automations can be applied to individual issues, subsets of issues and/or in accordance with some other defined scope.

The condition selection window 1002 presents a set of action components 1006 that are available to be added to the automation rule. A search input field 1004 may be used to search for and identify action components from the set of action components 1006. In one or more embodiments, one or more action components may include action components that utilize a generative output engine. For example, the summarize with AI action 1007 may be selectable to provide an action component that utilizes the generative output engine to provide a summary of a content portion of an object. In another example, the generated AI action items action 1009 may be selectable to provide an action component that utilizes the generative output engine to generate a list of action items from a content portion of an object. Examples of other condition components of the set of action components 1006 include a manage page public link action, a create sprint in platform action, a create incident in service management action, a block public links in space action, an add label action, a change page status action, and a publish new page action.

Generally, each action component of the set of action components 1006 indicates the action to be performed following the trigger component 1008 and satisfaction of the condition component 1010. The action indicates the object on which the action is performed. Actions are what the automation rule is to do or, stated differently, what happens if the automation rule executes successfully.

In some embodiments, the set of action components 1006 may be organized into one or more groups or subsets of action components. For example, the groups may include recommended pages and blogs, spaces, notifications, and an issue tracking system. In this example, the recommended actions include a transition an issue in an issue tracking system, edit an issue in an issue tracking system, add a label, change page status, create issue in an issue tracking system, publish a new page, restrict a page, or send an email. The pages and blogs actions include adding a comment, adding a label, archiving a page, changing a page owner, changing a page status, copying a page, deleting a blog, deleting a page, managing watchers, moving a page, publishing a new page, removing a label, or restricting a page. The spaces actions include archiving a space, creating a space, or granting space permissions. The notifications actions include sending an email, sending a message through a first platform (e.g., a Microsoft Teams message), sending a message through a second platform (e.g., a Slack message), sending a message through a third platform (e.g., a Twilio notification), or sending a web request. The actions include transitioning an issue, editing an issue, or creating an issue. The advance actions include creating a lookup table, creating a variable, or logging an action.

The action groups for the set of action components 1006 may be selectable via a set of tabs. For example, by selecting the “spaces” selectable element, the set of action components 1006 may be pared down to display only the associated spaces actions (e.g., archive space, create space, and grant space permission), and the other available action components hidden.

Search input field 1004 (e.g., a search box) accepts textual inputs from a user, and in response, the rule builder 1001 can filter the set of action components 1006. In some embodiments, the displayed set of action components 1006 may be pared down such that only action components that satisfy the search are displayed (and other, non-responsive action components are hidden). In other embodiments, a drop-down or pop-up may be displayed that includes selectable trigger components that satisfy the search.

In one or more embodiments, actions of the set of action components 1006 include one or more of email sending, application message sending, text message sending, web request sending, variable creation, action logging, or a combination of these. In some embodiments, these actions are for an issue tracking platform.

FIG. 11 depicts an example frontend interface 1100 that supports automation rule creation and automated content assessment for collaboration platforms. Frontend interface 1100 may be an example of frontend interface 1000 following selection by a user of a condition component that utilizes a generative output engine, for example summarize with AI action 1110. Following selection, the summarize with AI action 1110 may be shown as part of the automation rule flow.

For the summarize with AI action 1110, a component specification window 1102 may be displayed, for example when a user selects to include the summarize with AI action 1007 in the automation rule, or upon selection of the summarize with AI action 1110 during modification or editing of the automation rule flow. In one or more embodiments, the summarize with AI action 1110 may be used to create a summary that can then be used as a dynamic value/variable (e.g., a dynamic text reference 1108 (e.g., “{{generatedAISummary}}”)) that may be accessed and used by other actions of the automation rule, as described herein. For example, a next component may be an action component to send an email, create an issue, or update an existing issue, and the action component may use the dynamic text reference 1108 (e.g., “{{generatedAISummary}}”) to incorporate or otherwise utilize the generated summary.

In one or more embodiments, the component specification window 1102 includes an input field 1104 for a text input, such as a dynamic text reference (which may also be referred to as a “smart value”). In some examples, a set of dynamic text references 1106 may be selectable by a user when specifying parameters in the component specification window 1102. Examples of dynamic text references 1106 include references to values within a table (e.g., “{{tableName.get{myVal}}}”) or an AI-generated summary of a page (e.g., “{{page.aiSummary}}”).

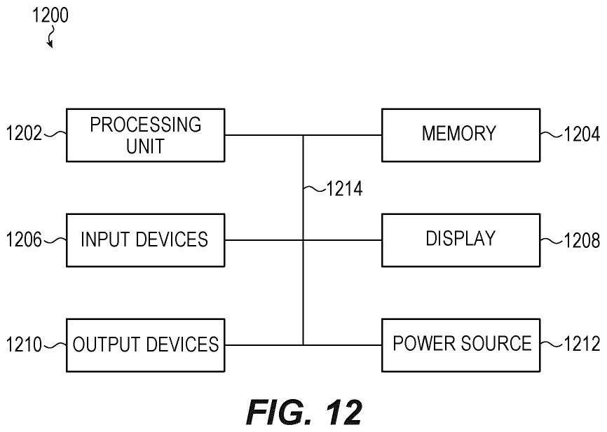

FIG. 12 shows a sample electrical block diagram of an electronic device(s) 1200 that may perform the operations described herein. For example, the electrical block diagram illustrates example components such as memory that stores instructions for performing the processes described herein and one or more processes, and/or other computer components that are configured to execute the stored instructions to perform the processes described herein. The electronic device(s) 1200 may in some cases take the form of any of the electronic devices described with reference to FIGS. 1-11 including client devices, and/or servers or other computing devices associated with the system 100. The electronic device 1200 can include one or more of a processing unit 1202, a memory 1204 or storage device, input device(s) 1206, a display 1208, output device(s) 1210, and a power source 1212. In some cases, various implementations of the electronic device 1200 may lack some or all of these components and/or include additional or alternative components.

The processing unit 1202 can control some or all of the operations of the electronic device 1200. The processing unit 1202 can communicate, either directly or indirectly, with some or all of the components of the electronic device 1200. For example, a system bus or other communication mechanism 1214 can provide communication between the processing unit 1202, the power source 1212, the memory 1204, the input device(s) 1206, and the output device(s) 1210. The processing unit 1202 may be operably coupled to the computer-readable memory 1204, which stores computer-readable instructions. The computer-readable instructions, when executed by the processing unit 1202 may cause the device or system to perform operations described herein with respect to the example embodiments and processes.

The processing unit 1202 can be implemented as any electronic device capable of processing, receiving, or transmitting data or instructions. For example, the processing unit 1202 can be a microprocessor, a central processing unit (CPU), an application-specific integrated circuit (ASIC), a digital signal processor (DSP), or combinations of such devices. As described herein, the term “processing unit” is meant to encompass a single processor or processing unit, multiple processors, multiple processing units, or other suitably configured computing element or elements.

It should be noted that the components of the electronic device 1200 can be controlled by multiple processing units. For example, select components of the electronic device 1200 (e.g., an input device 1206) may be controlled by a first processing unit and other components of the electronic device 1200 (e.g., the display 1208) may be controlled by a second processing unit, where the first and second processing units may or may not be in communication with each other.

The power source 1212 can be implemented with any device capable of providing energy to the electronic device 1200. For example, the power source 1212 may be one or more batteries or rechargeable batteries. Additionally, or alternatively, the power source 1212 can be a power connector or power cord that connects the electronic device 1200 to another power source, such as a wall outlet.

The memory 1204 can store electronic data that can be used by the electronic device 1200. For example, the memory 1204 can store electronic data or content such as audio and video files, documents and applications, device settings and user preferences, timing signals, control signals, and data structures or databases. The memory 1204 can be configured as any type of memory. By way of example only, the memory 1204 can be implemented as random access memory, read-only memory, flash memory, removable memory, other types of storage elements, or combinations of such devices.

In various embodiments, the display 1208 provides a graphical output, for example, associated with an operating system, user interface, and/or applications of the electronic device 1200 (e.g., a chat user interface, an issue-tracking user interface, an issue-discovery user interface, etc.). In one embodiment, the display 1208 includes one or more sensors and is configured as a touch-sensitive (e.g., single-touch, multi-touch) and/or force-sensitive display to receive inputs from a user. For example, the display 1208 may be integrated with a touch sensor (e.g., a capacitive touch sensor) and/or a force sensor to provide a touch-and/or force-sensitive display. The display 1208 is operably coupled to the processing unit 1202 of the electronic device 1200.

The display 1208 can be implemented with any suitable technology, including, but not limited to, liquid crystal display (LCD) technology, light emitting diode (LED) technology, organic light-emitting display (OLED) technology, organic electroluminescence (OEL) technology, or another type of display technology. In some cases, the display 1208 is positioned beneath and viewable through a cover that forms at least a portion of an enclosure of the electronic device 1200.

In various embodiments, the input device(s) 1206 may include any suitable components for detecting inputs. Examples of input device(s) 1206 include light sensors, temperature sensors, audio sensors (e.g., microphones), optical or visual sensors (e.g., cameras, visible light sensors, or invisible light sensors), proximity sensors, touch sensors, force sensors, mechanical devices (e.g., crowns, switches, buttons, or keys), vibration sensors, orientation sensors, motion sensors (e.g., accelerometers or velocity sensors), location sensors (e.g., global positioning system (GPS) devices), thermal sensors, communication devices (e.g., wired or wireless communication devices), resistive sensors, magnetic sensors, electroactive polymers (EAPs), strain gauges, electrodes, and so on, or some combination thereof. Each input device 1206 may be configured to detect one or more particular types of input and provide a signal (e.g., an input signal) corresponding to the detected input. The signal may be provided, for example, to the processing unit 1202.

As discussed above, in some cases, the input device(s) 1206 may include a touch sensor (e.g., a capacitive touch sensor) integrated with the display 1208 to provide a touch-sensitive display. Similarly, in some cases, the input device(s) 1206 may include a force sensor (e.g., a capacitive force sensor) integrated with the display 1208 to provide a force-sensitive display.

The output device(s) 1210 may include any suitable components for providing outputs. Examples of output device(s) 1210 include light emitters, audio output devices (e.g., speakers), visual output devices (e.g., lights or displays), tactile output devices (e.g., haptic output devices), communication devices (e.g., wired or wireless communication devices), and so on, or some combination thereof. Each output device 1210 may be configured to receive one or more signals (e.g., an output signal provided by the processing unit 1202) and provide an output corresponding to the signal.

In some cases, input devices 1206 and output devices 1210 are implemented together as a single device. For example, an input/output device or port can transmit electronic signals via a communications network, such as a wireless and/or wired network connection. Examples of wireless and wired network connections include, but are not limited to, cellular, Wi-Fi, Bluetooth, IR, and Ethernet connections.

The processing unit 1202 may be operably coupled to the input devices 1206 and the output devices 1210. The processing unit 1202 may be adapted to exchange signals with the input devices 1206 and the output devices 1210. For example, the processing unit 1202 may receive an input signal from an input device 1206 that corresponds to an input detected by the input device 1206. The processing unit 1202 may interpret the received input signal to determine whether to provide and/or change one or more outputs in response to the input signal. The processing unit 1202 may then send an output signal to one or more of the output devices 1210, to provide and/or change outputs as appropriate.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

One may appreciate that although many embodiments are disclosed above, that the operations and steps presented with respect to methods and techniques described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the embodiments of the invention, whether or not such embodiments are described, and whether or not such features are presented as being a part of a described embodiment. Thus, the breadth and scope of the present invention should not be limited by any of the above-described exemplary embodiments but should instead be defined by the claims herein presented.

Furthermore, the foregoing examples and description of instances of purpose-configured software, whether accessible via API as a request-response service, an event-driven service, or whether configured as a self-contained data processing service are understood as not exhaustive. The various functions and operations of a system, such as described herein, can be implemented in a number of suitable ways, developed leveraging any number of suitable libraries, frameworks, first or third-party APIs, local or remote databases (whether relational, NoSQL, or other architectures, or a combination thereof), programming languages, software design techniques (e.g., procedural, asynchronous, event-driven, and so on or any combination thereof), and so on. The various functions described herein can be implemented in the same manner (as one example, leveraging a common language and/or design), or in different ways. In many embodiments, functions of a system described herein are implemented as discrete microservices, which may be containerized or executed/instantiated by leveraging a discrete virtual machine, which are only responsive to authenticated API requests from other microservices of the same system. Similarly, each microservice may be configured to provide data output and receive data input across an encrypted data channel. In some cases, each microservice may be configured to store its own data in a dedicated encrypted database; in others, microservices can store encrypted data in a common database. whether such data is stored in tables shared by multiple microservices or whether microservices may leverage independent and separate tables/schemas can vary from embodiment to embodiment. As a result of these described and other equivalent architectures, it may be appreciated that a system such as described herein can be implemented in a number of suitable ways. For simplicity of description, many embodiments that follow are described in reference to an implementation in which discrete functions of the system are implemented as discrete microservices. It is appreciated that this is merely one possible implementation.

In addition, it is understood that organizations and/or entities responsible for the access, aggregation, validation, analysis, disclosure, transfer, storage, or other use of private data such as described herein will preferably comply with published and industry-established privacy, data, and network security policies and practices. For example, it is understood that data and/or information obtained from remote or local data sources, only on informed consent of the subject of that data and/or information, should be accessed only for legitimate, agreed-upon, and reasonable uses.

What is claimed is:

1. A method for defining a cross-project orchestration process, the method comprising:
causing display of an orchestration system user interface comprising a rule-library panel defining one or more issue definition blocks and a rule-generation panel configured to receive issue definition blocks and define a dependent relationship between one or more of the issue definition blocks;
in response to receiving one or more inputs to the orchestration system user interface, generating an orchestration process flow comprising:
a trigger object displayed in the rule-generation panel, the trigger object configured to receive data from an external application platform and define one or more trigger conditions based on the received data;
a parent issue definition block displayed in the rule-generation panel, the parent issue definition block defining one or more issue parameters used to generate a parent issue at an issue tracking system, wherein generation of the parent issue is initiated by the one or more trigger conditions;
a first issue definition block displayed in the rule-generation panel, the first issue definition block having a first dependent relationship to the parent issue definition block and comprising first issue data used to generate a first issue at the issue tracking system, the first dependent relationship used to define a first dependent relationship between the parent issue and the first issue at the issue tracking system;
a second issue definition block displayed in the rule-generation panel, the second issue definition block having a second dependent relationship to the parent issue definition block and comprising second issue data used to generate a second issue at the issue tracking system, wherein the second dependent relationship is used to define a second dependent relationship between the parent issue and the second issue at the issue tracking system; and
a condition element block displayed in the rule-generation panel and connecting the second issue definition block to the parent issue definition block, the condition element block defining one or more conditions for initiating creation of the second issue at the issue tracking system; and
subsequent to completion of the orchestration process flow and in response to determining, by an issue creation system, an occurrence of the one or more trigger conditions, causing generation of one or more issues at the issue tracking system in accordance with the orchestration process flow.

2. The method of claim 1, wherein in response to the occurrence of the one or more trigger conditions, causing generation, by the orchestration system user interface, of one or more status indicators for the orchestration process flow, the one or more status indicators displaying an issue creation status for each issue definition block of the orchestration process flow.

3. The method of claim 2, further comprising, in response to the creation of the parent issue at the issue tracking system in accordance with the parent issue definition block, causing display of a first issue creation status at the parent issue definition block, the first issue creation status indicating completion of the creation of the parent issue at the issue tracking system.

4. The method of claim 3, wherein:
the first issue creation status comprises a link configured to cause launch of an issue detail interface at the issue tracking system; and
in response to detecting a selection of the link, causing the issue tracking system to display the issue detail interface.

5. The method of claim 1 wherein:
each issue definition block for the orchestration process flow displayed in the rule-generation panel comprises an option to edit a respective issue definition block; and
selection of the option to edit the respective issue definition block causes display of an editing interface for defining one or more issue parameters used to generate respective issues at the issue tracking system.

6. The method of claim 1, wherein:
each issue definition block for the orchestration process flow displayed in the rule-generation panel comprises an option to add logic to a respective issue definition block; and
selection of the option to add logic to the respective issue definition block causes display of a logic interface for defining one or more logic parameters defining parameters that cause generation of the respective issue at the issue tracking system.

7. The method of claim 1, wherein:
the rule-library panel comprises one or more pre-defined issue definition blocks; and
generating at least one of the parent issue definition blocks, the first issue definition block or the second issue definition block comprises using a pre-defined issue definition block from the one or more pre-defined issue definition blocks.

8. The method of claim 1, wherein:
the rule-library panel comprises one or more pre-defined issue definition blocks; and
the orchestration system user interface is configured to allow the one or more pre-defined issue definition blocks to be moved from the rule-library panel to the rule-generation panel.

9. The method of claim 8, wherein the placement of a pre-defined issue definition block of the one or more pre-defined issue definition blocks with respect to issue definition blocks in the rule-generation panel defines a dependent relationship of the pre-defined issue definition block with respect to the issue definition blocks in the rule-generation panel.

10. A method for defining a cross-project orchestration process, the method comprising:
causing display of an orchestration system user interface comprising a rule-library panel defining one more issue definition blocks and a rule-generation panel configured to receive issue definition blocks and define a dependent relationship between one or more of the issue definition blocks;
in response to receiving one or more inputs to the orchestration system user interface, generating an orchestration process flow comprising:
a trigger object displayed in the rule-generation panel, the trigger object configured to receive data from an external application platform and define one or more trigger conditions based on the received data; and
multiple issue definition blocks displayed in the rule-generation panel, each issue definition block defining one or more issue parameters used to generate a respective issue at an issue tracking system, the multiple issue definition blocks comprising:
a first issue definition block defining one or more first issue parameters used to generate a first issue at the issue tracking system; and
a second issue definition block defining one or more second issue parameters used to generate a second issue at the issue tracking system, wherein placement of the second issue definition block with respect to the first issue definition block defines a dependent relationship of the first issue with respect to the second issue at the issue tracking system; and
subsequent to completion of the orchestration process flow and in response to determining an occurrence of the one or more trigger conditions, causing generation of one or more issues at the issue tracking system in accordance with the orchestration process flow.

11. The method of claim 10, wherein:
the second issue definition block further defines one or more conditions for initiating creation of the second issue at the issue tracking system; and
the orchestration process flow comprises a condition element block displayed in the rule-generation panel and connecting the second issue definition block to the first issue definition block, the condition element block displaying an indication of the one or more conditions for initiating the creation of the second issue.

12. The method of claim 10, wherein:
each issue definition block of the multiple issue definition blocks comprises an option to edit a respective issue definition block; and
in response to detecting selection of the option to edit the respective issue definition block, causing display of an editing interface for defining one or more issue parameters used to generate respective issues at the issue tracking system.

13. The method of claim 12, wherein causing display of the editing interface comprises causing display of one or more fields for defining one or more issue parameters used to generate a respective issue at the issue tracking system.

14. The method of claim 13, wherein causing display of the editing interface comprises:
accessing a back-end of an external application platform; and
causing display or one or more dynamic parameters corresponding to data hosted by the back-end of the external application platform, the one or more dynamic parameters configured to be applied to the one or more fields.

15. The method of claim 10, wherein the rule-library panel comprises one or more pre-defined definition blocks and at least one of the parent issue definition block, the first issue definition block or the second issue definition blocks are generated using a pre-defined definition block from the one or more pre-defined definition blocks.

16. An issue orchestration system operating on one or more servers, the issue orchestration system comprising a backend application operably coupled to a frontend application operating on a client device, the issue orchestration system backend application configured to:
cause display, at the frontend application, of an orchestration system user interface comprising a rule-library panel comprising one or more issue definitions blocks and a rule-generation panel configured to receive issue definitions blocks and define a dependent relationship between one or more of the issue definition blocks;
in response to receiving one or more inputs to the orchestration system user interface, generate an orchestration process flow comprising:
a trigger object configured to receive data from an external application platform and define one or more trigger conditions based on the received data; and
multiple issue definition blocks each defining one or more issue parameters used to generate a respective issue at an issue tracking system, the multiple issue definition blocks comprising:
a first issue definition block defining one or more first issue parameters used to generate a first issue at an issue tracking system; and
a second issue definition block defining one or more second issue parameters used to generate a second issue at the issue tracking system and defining a dependent relationship of the first issue with respect to the second issue at the issue tracking system; and
subsequent to completion of the orchestration process flow and in response to determining an occurrence of the one or more trigger conditions, cause generation of one or more issues at the issue tracking system in accordance with the orchestration process flow.

17. The issue orchestration system of claim 16, wherein:
the backend application is configured to execute multiple instances of the orchestration process flow; and
each instance of the orchestration process flow is executed in response to determining a separate occurrence of the one or more trigger conditions.

18. The issue orchestration system of claim 17, wherein:
a first instance of the orchestration process flow is executed in response to determining the occurrence of the one or more trigger conditions with respect to a first user account;
the backend application is configured to cause generation of one or more first issues at the issue tracking system for the first user account;
a second instance of the orchestration process flow is executed in response to determining the occurrence of the one or more trigger conditions with respect to a second user account; and
the backend application is configured to cause generation of one or more second issues at the issue tracking system for the first user account.

19. The issue orchestration system of claim 16, wherein the backend application is configured to, in response to creation of the first issue at the issue tracking system in accordance with the first issue definition block, cause display of a first issue creation status at the first issue definition block.

20. The issue orchestration system of claim 16, wherein:
the rule-library panel comprises one or more pre-defined issue definition blocks; and
generating at least one of the first issue definition block or the second issue definition blocks comprises using a pre-defined issue definition block from the one or more pre-defined issue definition blocks.
